(19) United States
(12) Patent Application Publication
(10) Pub. No.: US 2023/0160401 A1
(43) Pub. Date: May 25, 2023

(54) ACTUATOR WITH INTEGRATED COOLING

(71) Applicant: Hamilton Sundstrand Corporation, Charlotte, NC (US)

(72) Inventors: Ryan Susca, Windsor, CT (US); Murtuza Lokhandwalla, South Windsor, CT (US); Morgan O'Rorke, West Hartford, CT (US)

(21) Appl. No.: 17/532,377

(22) Filed: Nov. 22, 2021

(51) Int. Cl. F15B 15/14

(52) U.S. Cl. CPC F15B 15/1485; F15B 15/1452; F15B 15/149

(57) ABSTRACT

An actuator is provided. The actuator includes a first body defining an interior, a second body disposed about the first body and defining space between an exterior of the first body and an interior of the second body, a plunger including a head sealably disposed in the interior and a rod connected to the head and sealably extended through the first and second bodies and first and second fluid systems. The first fluid system is insulated from the space. A first fluid is moved relative to the interior for causing the plunger to extend or retract by way of the first fluid system. A second fluid is moved through the space by way of the second fluid system.

### BACKGROUND

The present disclosure relates to actuators and, more particularly, to an actuator with integrated cooling.

In aircraft and other applications, actuators can be used to cause other components to move in a given manner. For example, in an aircraft, an actuator can be connected to a controllable surface to cause that controllable surface to pivot upwardly or downwardly based on current conditions. In other cases, an actuator in a gas turbine engine of an aircraft can be used to control openings and closings of doors or valves.

Developing actuators for use in gas turbine engines, in particular, presents several unique challenges. Among these is the challenge of designing the actuators to be able to survive a fire in an operation or a certification test. Normally, when an actuator is operating and moving, fuel or another fluid circulates in and out of the actuator body to aid in actuator cooling and/or seal cooling. When the actuator is not moving, however, fuel does not circulate in and out of the actuator body to aide in actuator cooling and it becomes necessary to provide the actuator with heavy thermal blanketing. This heavy thermal blanketing is typically added to the exterior of the actuator to survive fire or other high-temperature conditions.

The heavy thermal blanketing adds significant weight and envelope to the actuator and can be prone to damage during engine servicing.

### BRIEF DESCRIPTION

According to an aspect of the disclosure, an actuator is provided. The actuator includes a first body defining an interior, a second body disposed about the first body and defining space between an exterior of the first body and an interior of the second body, a plunger including a head sealably disposed in the interior and a rod connected to the head and sealably extended through the first and second bodies and first and second fluid systems. The first fluid system is insulated from the space. A first fluid is moved relative to the interior for causing the plunger to extend or retract by way of the first fluid system. A second fluid is moved through the space by way of the second fluid system.

In accordance with additional or alternative embodiments, the first fluid includes fuel and the second fluid includes coolant.

In accordance with additional or alternative embodiments, the second fluid includes one or more of air, engine oil and a liquid- or air-based media.

In accordance with additional or alternative embodiments, an envelope of the actuator is substantially delimited by an exterior shape and size of the second body.

In accordance with additional or alternative embodiments, the first and second bodies include first and second snouts, respectively, and the actuator further includes first seals engageable between the head and the first body, second seals engageable between the rod and the first snout and third seals engageable between the rod and the second snout.

In accordance with additional or alternative embodiments, the first fluid system includes a first port and a second port which extend from an exterior of the second body, through the space and into the interior and the second fluid system includes an inlet and an outlet which extend from an exterior of the second body and into the space.

In accordance with additional or alternative embodiments, stoppers are disposed to constrain the first body relative to the second body.

According to an aspect of the disclosure, a heat exchanger including the actuator is provided where the first fluid is at a first temperature and the second fluid is at a second temperature which is different from the first temperature.

In accordance with additional or alternative embodiments, the first fluid includes fuel and the second fluid includes coolant.

In accordance with additional or alternative embodiments, the second fluid includes one or more of air, engine oil and a liquid- or air-based media.

In accordance with additional or alternative embodiments, the coolant is temporarily hotter than the fuel.

In accordance with additional or alternative embodiments, the first fluid includes fuel and the second fluid includes air which is hotter than the fuel.

According to an aspect of the disclosure, a method of assembling an actuator is provided. The method includes arranging a partial first body within a partial second body, coupling a first fluid system, which is insulated from a space between the partial first body and the partial second body that is unenclosed, with an interior of the partial first body that is unenclosed, coupling a second fluid system with the space, inserting a head of a plunger with a rod connected thereto into the interior of the partial first body, sliding a first snout over the rod and into the partial first body to enclose the interior and sliding a second snout over the rod and into the partial second body to enclose the space.

In accordance with additional or alternative embodiments, the method further includes additively manufacturing at least the partial first body and the partial second body.

In accordance with additional or alternative embodiments, the method further includes arranging first seals between the head and the partial first body, arranging second seals between the first snout and the rod and arranging third seals between the second snout and the rod.

In accordance with additional or alternative embodiments, the method further includes constraining the partial first body relative to the partial second body.

According to an aspect of the disclosure, a method of assembling an actuator is provided. The method includes arranging a partial first body with a first snout within a partial second body with a second snout, coupling a first fluid system, which is insulated from a space between the partial first body and the partial second body that is unenclosed, with an interior of the partial first body that is unenclosed, coupling a second fluid system with the space, inserting a head of a plunger with a rod connected thereto into the interior of the partial first body such that the rod extends through the first snout and the second snout, attaching a first end cap to the first partial body to enclose the interior and attaching a second end cap to the second partial body to enclose the space.

In accordance with additional or alternative embodiments, the method further includes additively manufacturing at least the partial first body and the partial second body.

In accordance with additional or alternative embodiments, the method further includes arranging first seals between the head and the partial first body, arranging second seals between the first snout and the rod and arranging third seals between the second snout and the rod.

In accordance with additional or alternative embodiments, the method further includes constraining the partial first body relative to the partial second body.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a schematic side view of an actuator in accordance with embodiments;

FIG. 2 is a flow diagram illustrating a method of assembling an actuator in accordance with embodiments;

FIG. 3 is a graphical depiction of the method of FIG. 2 in accordance with embodiments;

FIG. 4 is a flow diagram illustrating a method of assembling an actuator in accordance with embodiments; and

FIG. 5 is a graphical depiction of the method of FIG. 4 in accordance with embodiments.

### DETAILED DESCRIPTION

As will be described below, an actuator is provided with an integrated cooling system. The actuator can be produced through additive manufacturing techniques, for example, and includes a series of cooling passages that surround the hydraulic body of the actuator. A fluid or gas, such as air (e.g., engine bleed/bypass air, or ram air from outside the aircraft), can flow through the cooling passages. This creates a thermal barrier to protect the fuel seals of the actuator from fire or extreme heat of a fire.

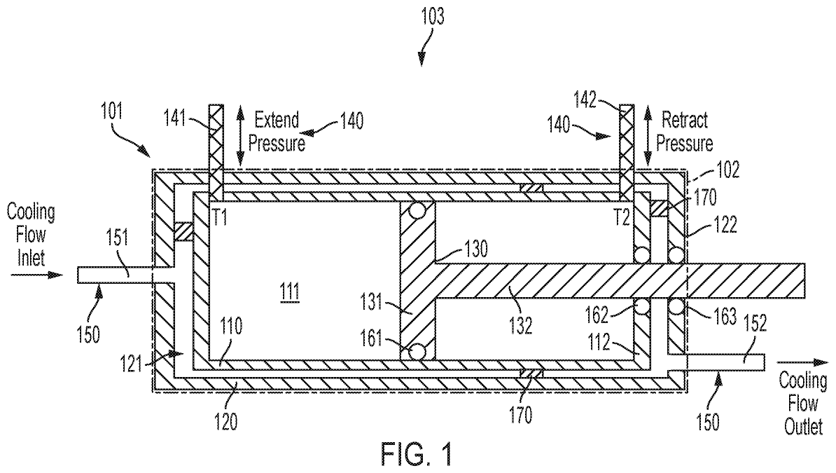

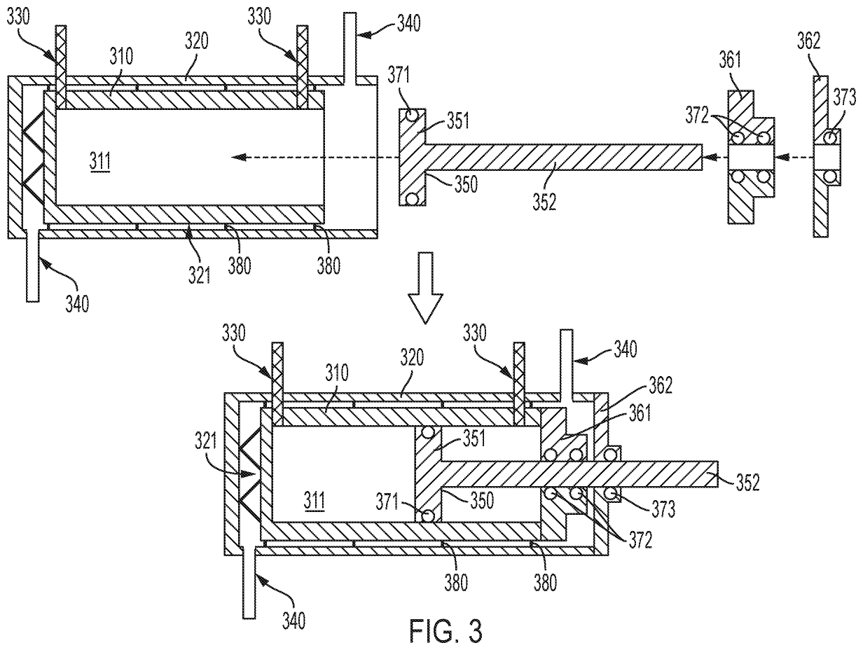

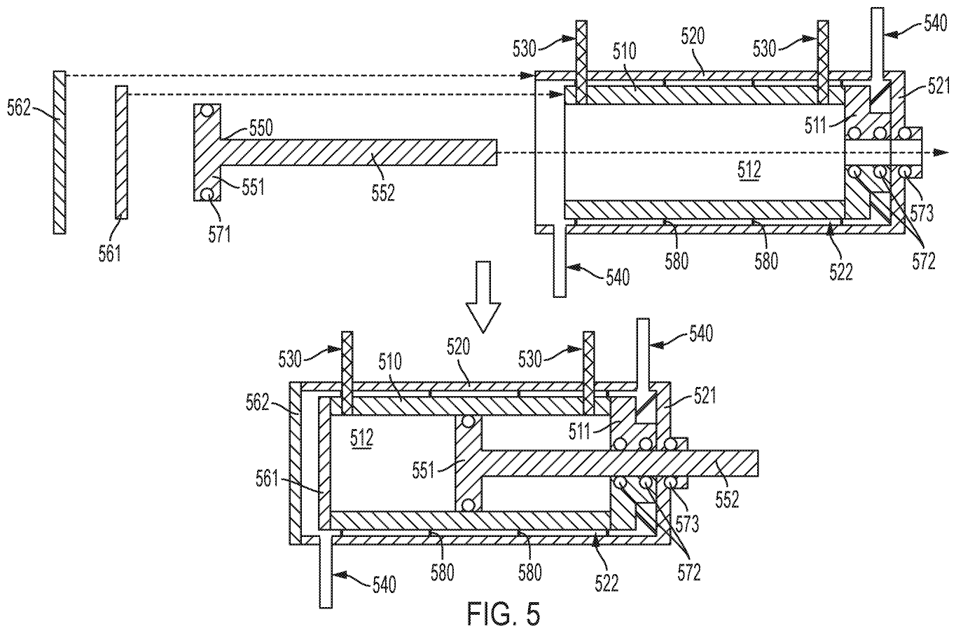

With reference to FIG. 1, an actuator 101 is provided and includes a first body 110, a second body 120, a plunger 130, a first fluid system 140 and a second fluid system 150. The first body 110 is formed to define an interior 111 and is arranged within the second body 120. The second body 120 is thus disposed about the first body 110 and defines a space 121 between an exterior of the first body 110 and an interior of the second body 120. Stoppers 170 can be disposed in the space 121 to constrain or prevent movement of the first body 110 relative to the second body 120. The plunger 130 includes a head 131 and a rod 132 connected to the head 131. The head 131 is sealably disposed in the interior 111. The rod 132 extends from the head 131 and sealably extends through the first body 110 (i.e., through a portion of the first body 110 that can be provided as a first snout 112 and as shown in FIGS. 3 and 5 and as described below) and through the second body 120 (i.e., through a portion of the second body 120 that can be provided as a second snout 122 and as shown in FIGS. 3 and 5 and as described below). The first fluid system 140 is insulated from the space 121 and is configured to move a first fluid relative to the interior 111 to thereby cause the plunger 130 to extend or retract. The second fluid system 150 is configured to move a second fluid through the space 121 and includes an inlet 151 (i.e., a cooling flow inlet) and an outlet 152 (i.e., a cooling flow outlet).

First seals 161 can be provided between the head 131 and an interior surface of the first body 110. Second seals 162 can be provided between an exterior surface of the rod 132 and the first snout 112. Third seals 163 can be provided between the exterior surface of the rod 132 and the second snout 122. The first fluid system 140 includes a first port 141 and a second port 142. The first port 141 extends from an exterior of the second body 120, through the space 121 and into the interior 111 at a first side (i.e., an extend side) of the head 131 and the first seals 161. The second port 142 extends from the exterior of the second body 120, through the space 121 and into the interior 111 at a second side (i.e., a retract side) of the head 131 and the first seals 161.

When the first fluid in the first port 141 and at the first side of the head 131 and the first seals 161 has a greater pressure than the first fluid in the second port 142 and at the second side of the head 131 and the first seals 161, the plunger 130 is extended through the first snout 112 and the second snout 122 as long as there is no loading applied to the rod to resist the extension. Conversely, when the first fluid in the second port 142 and at the second side of the head 131 and the first seals 161 has a greater pressure than the first fluid in the first port 141 and at the first side of the head 131 and the first seals 161, the plunger 130 could be retracted unless the retract area exposed to the pressure of the second port 142 is less than the extend area exposed to the pressure of the first port 141 (area is smaller by the area of the plunger rod 132). Notably, force=pressure*area, so force balance (no motion) is achieved when the pressure at the second port 142 is higher than the pressure at the first port 141.

In accordance with embodiments, the first fluid can include or be provided as fuel and the second fluid can include or be provided as coolant. In some cases, the second fluid can include or be provided as one or more of air, engine oil and a liquid- or air-based media.

In any case, since the second fluid can be provided as coolant, the actuator 101 has an available cooling system and does not need to be surrounded or embedded in heavy thermal blanketing. As such, the actuator 101 can be deployed or installed in a system without heavy thermal blanketing such that an envelope 102 of the actuator 101 is substantially delimited by an exterior shape and size of the second body 120.

In accordance with additional or further embodiments, the actuator 101 can be provided as or a part of a heat exchanger 103. In these or other cases, the first fluid can be provided to the actuator 101 acting as the heat exchanger 103 at a first temperature T1 and the second fluid can be provided to the actuator 101 acting as the heat exchanger 103 at a second temperature T2, which is different from the first temperature. In an exemplary case, as above, the first fluid can include or be provided as fuel and the second fluid can include or be provided as coolant such as one or more of air, engine oil and a liquid- or air-based media. In some instances, the actuator 101 acting as the heat exchanger 103 can be operated in a reverse thermal exchange mode in which the coolant, which would normally be colder than the fuel, is at least temporarily hotter than the fuel (i.e., when exterior air is hotter than the fuel during ground conditions).

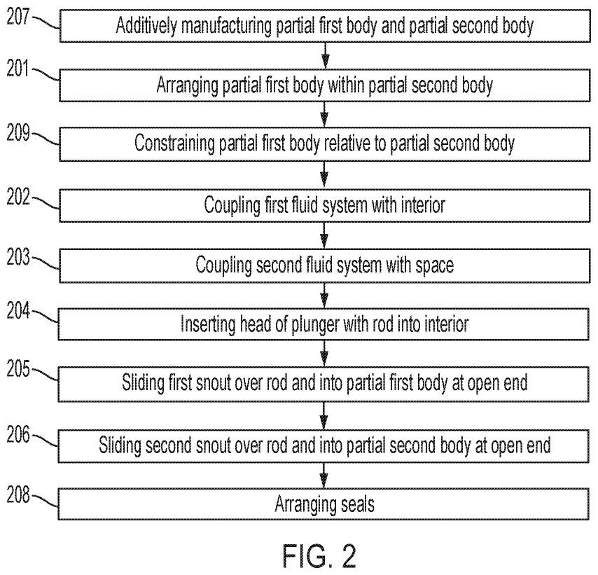

With reference to FIGS. 2 and 3, a method of assembling an actuator, such as the actuator 101 of FIG. 1 described above, is provided. The method includes arranging a partial first body 310 within a partial second body 320 (block 201), coupling a first fluid system 330, which is insulated from a space 321 between the partial first body 310 and the partial second body 320 that is at least initially unenclosed, with an interior 311 of the partial first body 310 that is also at least initially unenclosed (block 202) and coupling a second fluid system 340 with the space 321 (block 203). In accordance with embodiments, the partial first body 310 can include sidewalls, a closed end at one end of the sidewalls and an open end at the other end of the sidewalls. Similarly, the partial second body 320 can include sidewalls, a closed end at one end of the sidewalls that corresponds to the closed end of the partial first body 310 and an open end at the other end of the sidewalls that corresponds to the open end of the partial first body 310. The method further includes inserting ahead 351 of a plunger 350 with a rod 352 connected thereto into the interior 311 of the partial first body 310 (block 204) such that the rod 352 extends away from the head 351 and out of the interior 311 and the space 321. In addition, the method includes sliding a first snout 361 over the rod 352 and into the partial first body 310 at the open end to enclose the interior 311 (block 205) and sliding a second snout 362 over the rod 352 and into the partial second body 320 at the open end to enclose the space 321 (block 206).

In accordance with embodiments, the method can also include additively manufacturing at least the partial first body 310 and the partial second body 320 prior to the arranging of block 201 (block 207). This additive manufacturing can be achieved by any additive manufacturing or three-dimensional (3D) printing processes. Also, the method can include arranging first seals 371 between the head 351 and the partial first body 310, arranging second seals 372 between the first snout 361 and the rod 352 and arranging third seals 373 between the second snout 362 and the rod 352 (block 208) and constraining movement of the partial first body 310 relative to the partial second body 320 (block 209) using stoppers 380.

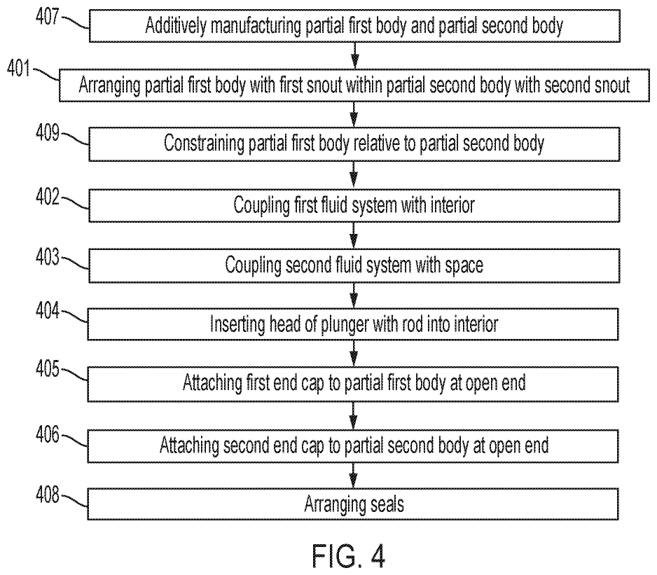

With reference to FIGS. 4 and 5, a method of assembling an actuator, such as the actuator 101 of FIG. 1 described above, is provided. The method includes arranging a partial first body 510 with a first snout 511 within a partial second body 520 with a second snout 521 (block 401), coupling a first fluid system 530, which is insulated from a space 522 between the partial first body 510 and the partial second body 520 that is at least initially unenclosed, with an interior 512 of the partial first body 510 that is also at least initially unenclosed (block 402) and coupling a second fluid system 540 with the space 522 (block 403). In accordance with embodiments, the partial first body 510 can include sidewalls, a closed end at one end of the sidewalls, which is closed by the first snout 511, and an open end at the other end of the sidewalls. Similarly, the partial second body 520 can include sidewalls, a closed end at one end of the sidewalls, which is closed by the second snout 521 and which corresponds to the closed end of the partial first body 310, and an open end at the other end of the sidewalls that corresponds to the open end of the partial first body 310. The method further includes inserting a head 551 of a plunger 550 with a rod 552 connected thereto into the interior 512 of the partial first body 510 such that the rod 552 extends away from the head 551 and out of the interior 511 through the first snout 511 and out of the space 521 through the second snout 521 (block 404). In addition, the method includes attaching a first end cap 561 to the partial first body 510 at the open end thereof to enclose the interior 512 (block 405) and attaching a second end cap 562 to the partial second body 520 at the open end thereof to enclose the space 522 (block 406).

In accordance with embodiments, the method can also include additively manufacturing at least the partial first body 510 and the partial second body 520 prior to the arranging of block 401 (block 407). This additive manufacturing can be achieved by any additive manufacturing or three-dimensional (3D) printing processes. Also, the method can include arranging first seals 571 between the head 551 and the partial first body 510, arranging second seals 572 between the first snout 511 and the rod 552 and arranging third seals 573 between the second snout 521 and the rod 552 (block 408) and constraining movement of the partial first body 510 relative to the partial second body 520 (block 409) using stoppers 580.

Technical effects and benefits of the present disclosure are the provision of an actuator with integrated cooling passages. This eliminates heavy thermal blanketing and thus offers significant weight and envelope reduction for the actuator as well as reducing the tendency of actuator features being damaged during servicing. The integrated cooling passages could also allow actuators to operate in hotter ambient temperature environments that current technology allows. In addition, the actuator with integrated cooling passages could be used in reverse operations for normal operating conditions, where air is hotter than fuel, in which case the actuator could act as a fuel/air heat exchanger to cool air.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

1. An actuator, comprising:
a first body defining an interior having first and second opposed sides;
a second body disposed about the first body and defining a space between the first body and the second body and having first and second opposed sides corresponding to the first and second opposed sides of the interior of the first body;
a plunger comprising a head sealably disposed in the interior of the first body and a rod connected to the head and sealably extended through the first and second bodies;
a first fluid system, by which a first fluid is moved relative to the interior of the first body for causing the plunger to extend or retract and which is insulated from a flow of the first fluid into the space; and
a second fluid system by which a second fluid is moved through the space,
wherein:
the first fluid system comprises a first port and a second port which extend from an exterior of the second body, through the space and respectively into the first and second opposed sides of the interior of the first body,
the plunger is caused to extend by an extend pressure at the first port being increased to be greater than a retract pressure at the second port,
the plunger is caused to retract by the retract pressure at the second port being increased to be greater than the extend pressure at the second port, and
the second fluid system comprises an inlet and an outlet which extend from or to the exterior of the second body and respectively terminate into or begin from the first and second opposed sides of the space.

2. The actuator according to claim 1, wherein the first fluid comprises fuel and the second fluid comprises coolant.

3. The actuator according to claim 2, wherein the second fluid comprises one or more of air, engine oil and a liquid- or air-based media.

4. The actuator according to claim 1, wherein an envelope of the actuator is substantially delimited by an exterior shape and size of the second body.

5. The actuator according to claim 1, wherein:
the first and second bodies comprise first and second snouts, respectively, and
the actuator further comprises first seals engageable between the head and the first body, second seals engageable between the rod and the first snout and third seals engageable between the rod and the second snout.

6. (canceled)

7. The actuator according to claim 1, further comprising stoppers disposed to constrain the first body relative to the second body.

8. A heat exchanger comprising the actuator according to claim 1, wherein:
the first fluid is at a first temperature, and
the second fluid is at a second temperature which is different from the first temperature.

9. The actuator according to claim 8, wherein the first fluid comprises fuel and the second fluid comprises coolant.

10. The actuator according to claim 9, wherein the second fluid comprises one or more of air, engine oil and a liquid- or air-based media.

11. The actuator according to claim 9, wherein the coolant is temporarily hotter than the fuel.

12. The actuator according to claim 8, wherein the first fluid comprises fuel and the second fluid comprises air which is hotter than the fuel.

13. A method of assembling an actuator, the method comprising:
arranging a partial first body within a partial second body;
coupling a first fluid system, which is insulated from a space between the partial first body and the partial second body that is unenclosed, with an interior of the partial first body that is unenclosed;
coupling a second fluid system with the space;
inserting a head of a plunger with a rod connected thereto into the interior of the partial first body;
sliding a first snout over the rod and into the partial first body to enclose the interior; and
sliding a second snout over the rod and into the partial second body to enclose the space.

14. The method according to claim 13, further comprising additively manufacturing at least the partial first body and the partial second body.

15. The method according to claim 13, further comprising arranging first seals between the head and the partial first body, arranging second seals between the first snout and the rod and arranging third seals between the second snout and the rod.

16. The method according to claim 13, further comprising constraining the partial first body relative to the partial second body.

17. A method of assembling an actuator, the method comprising:
arranging a partial first body with a first snout within a partial second body with a second snout;
coupling a first fluid system, which is insulated from a space between the partial first body and the partial second body that is unenclosed, with an interior of the partial first body that is unenclosed;
coupling a second fluid system with the space;
inserting a head of a plunger with a rod connected thereto into the interior of the partial first body such that the rod extends through the first snout and the second snout;
attaching a first end cap to the first partial body to enclose the interior; and
attaching a second end cap to the second partial body to enclose the space.

18. The method according to claim 17, further comprising additively manufacturing at least the partial first body and the partial second body.

19. The method according to claim 17, further comprising arranging first seals between the head and the partial first body, arranging second seals between the first snout and the rod and arranging third seals between the second snout and the rod.

20. The method according to claim 17, further comprising constraining the partial first body relative to the partial second body.
